(19) United States
(12) Patent Application Publication
(10) Pub. No.: US 2005/0251297 A1
(43) Pub. Date: Nov. 10, 2005

(54) System for remotely starting the engine of a vehicle that has a manual transmission

(76) Inventors: Normand Dery, Sherbrooke (CA); Patrick Allen, Sherbrooke (CA); Steve Picard, St-Elie d'Orford (CA)

Correspondence Address: FETHERSTONHAUGH - SMART & BIGGAR, 1000 DE LA GAUCHETIERE WEST, SUITE 3300, MONTREAL, QC, H3B 4W5, CA

(21) Appl. No.: 10/837,662

(22) Filed: May 4, 2004

(51) Int. Cl. G06F 19/00

(52) U.S. Cl. 701/2; 701/54

(57) ABSTRACT

A slave controller for mounting in a vehicle having an engine for driving at least one wheel of the vehicle via a manual transmission and a cabin having a plurality of components for operation by a user of the vehicle while in the cabin. The slave controller has a control module responsive to an RF signal conveying an engine start command for starting the engine of the vehicle. The control module is capable of performing a transmission state check to determine if the engine is in a driving relationship with the wheel. When the transmission state check is performed and the control module determines that the engine is in a driving relationship with the wheel, the control module acquires an operational state preventing starting of the engine in response to the RF signal. The control module is responsive to actuation of one or more of the plurality of components to initiate the transmission state check.

### FIELD OF THE INVENTION

The invention relates to a slave controller for remotely starting the engine of a vehicle having a manual transmission

### BACKGROUND OF THE INVENTION

Manufacturers of cars or trucks having automatic transmissions are required to install a so-called park/neutral switch in the vehicle, which prevents the operation of the starter motor when the transmission is in driving engagement with the wheels. Typically the switch is connected to the shift linkage of the transmission. When the transmission is shifted in PARK or NEUTRAL the switch allows the engine to be cranked by closing the electric circuit of the starter motor. In any other transmission mode the switch assumes an open condition preventing the starter motor from being energized.

After market remote vehicle starting systems that function by way of radio link are designed to interface with the park/neutral switch in order to determine if the transmission is in a mode allowing the engine to be remotely started in a safe manner. Typically, the slave controller of the starting system, which is mounted on board the vehicle, observes the state of conduction of the park/neutral switch, upon reception of an RF signal conveying an engine start command. The slave controller will implement the start engine command only if the park/neutral switch is closed.

However, most cars or trucks having a manual transmission have no factory-installed device allowing determining whether the transmission is in neutral or in gear. In an attempt to overcome this limitation, manufacturers of remote vehicle starting systems have developed simple electromechanical switches coupled to the shift linkage of the transmission. This approach is satisfactory when the switch is new. However, the protection it offers against remote starting with the transmission in gear is compromised over time because the switch may eventually malfunction as a result of normal wear or simply lack of proper adjustment. In view of the serious consequences which could result from remote starting of a motor vehicle with the transmission in gear, the industry is presently trying to develop a fail safe device that would positively prevent the engine from starting unless the transmission is, in fact, in the neutral position (or park, if available).

One solution that has been developed recently and which does not rely entirely on a switch or component sensing whether or not the transmission is in gear is described in the U.S. Pat. No. 5,656,868 granted to Designtech International Inc. on Aug. 12, 1997. The contents of this document are hereby incorporated by reference. The approach allows the remote vehicle starting system to respond to an RF signal containing an engine start command only when a special safety sequence has been run. In short, when the user parks the vehicle, he or she will initiate the safety sequence via the remote transmitter normally used to remotely start the engine. The slave controller in the vehicle responds to the RF signal by keeping the engine running even after the key has been removed from the ignition switch. The user can leave the car while the engine is still running. The slave controller detects that the user has left by observing the state of conduction of the door switch. Once the user has left, he or she can send another RF signal via the remote transmitter that will allow the slave controller to shut down the engine. At this point the safety sequence has been completed and the slave controller has positively verified that the transmission is in neutral (otherwise the vehicle would be moving). The slave controller now acquires an operative state such that it will respond to an RF signal containing an engine start command by starting the engine.

The technique proposed in the U.S. Pat. No. 5,656,868 is an advance in the art, however it presents a number of problems. The present invention aims to solve or at least alleviate those problems.

### SUMMARY OF THE INVENTION

Under a first broad aspect, the invention provides a slave controller for mounting in a vehicle having an engine for driving at least one wheel of the vehicle via a manual transmission and a cabin having a plurality of components for operation by a user of the vehicle while in the cabin. The slave controller has a control module responsive to an RF signal conveying an engine start command for starting the engine of the vehicle. The control module is capable of performing a transmission state check to determine if the engine is in a driving relationship with the wheel. When the transmission state check is performed and the control module determines that the engine is in a driving relationship with the wheel, the control module acquires an operational state preventing starting of the engine in response to the RF signal. The control module is responsive to actuation of one or more of the plurality of components to initiate the transmission state check.

Examples of components that can be used to initiate the transmission state check include the hand brake, the brake pedal or lights of the vehicle.

Under a second broad aspect, the invention provides a slave controller for mounting in a vehicle having an engine for driving at least one wheel of the vehicle via a manual transmission and a cabin having a plurality of components for operation by a user of the vehicle while in the cabin. The slave controller has a control module responsive to an RF signal conveying an engine start command for starting the engine of the vehicle. The control module is capable of performing a transmission state check to determine if the engine is in a driving relationship with the wheel. The control module is operative to generate a status signal for alerting the user about the status of the transmission state check.

Under a third broad aspect, the invention provides a slave controller for mounting in a vehicle having an engine. The slave controller is capable of being configured to function in a vehicle having an automatic transmission or in a vehicle having a manual transmission. The slave controller has a control module capable of acquiring a plurality of operative states, including an automatic transmission operative state and a manual transmission operative state, the automatic transmission operative state being suitable when the slave controller is mounted in a vehicle having an automatic transmission and the manual transmission operative state being suitable when said slave controller is mounted in a vehicle having a manual transmission. The control module includes an input for connection to at least one component of the vehicle to obtain status information on at least one component required during the manual transmission operative state. The control module has an interlock precluding the control module from acquiring the manual transmission operative state when at least one component is not connected to the input.

### BRIEF DESCRIPTION OF THE DRAWINGS

A detailed description of examples of implementation of the present invention is provided hereinbelow with reference to the following drawings, in which:

FIG. 1 illustrates a vehicle starting system;

FIG. 2 is a block diagram of the slave controller of a remote vehicle starting system, mounted on board the vehicle; and

FIG. 3 is a detailed block diagram of the slave controller.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

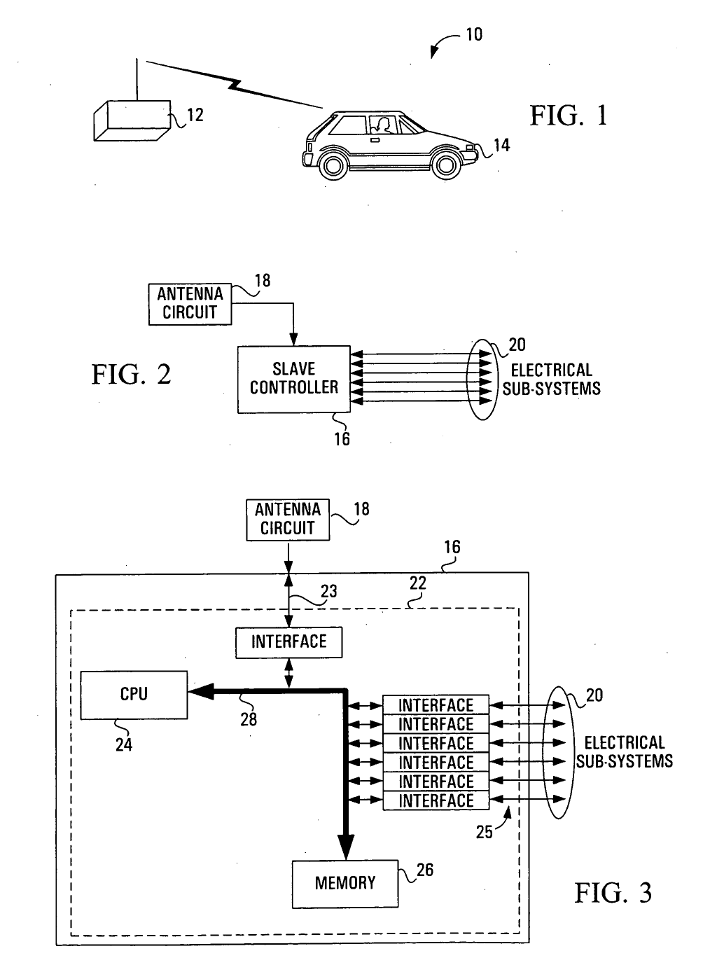

FIG. 1 is a simplified illustration of a remote vehicle starting system 10. The system 10 has two components, namely a remote transmitter 12 that can be of hand-held configuration for ease of use, and a slave controller 16 mounted on-board the vehicle 14 that has an internal combustion engine started by a starter motor. The remote transmitter 12 and the slave controller 16 establish a Radio Frequency (RF) communication between them. This RF communication serves the basic purpose of transmitting commands from the remote transmitter 12 to the slave controller 16 that, in turn, implements those commands. One of those commands is to start the engine, which is effected by cranking the starter motor.

In one form of implementation, the RF communication is unidirectional, that is commands are sent from the remote transmitter 12 to the slave controller 16. Optionally, the RF communication can be bi-directional where information is exchanged between the remote transmitter 12 and the slave controller 16.

The RF communication is effected under a specified protocol that can vary greatly according to the intended application. This feature is an implementation detail not critical to the present invention.

Note that while the drawings show a vehicle 14 in the form of an automobile, the invention also finds applications for vehicles other than automobiles, such as boats, or other vehicles powered by an internal combustion engine started by a starter motor.

FIG. 2 illustrates a block diagram of the slave controller 16 mounted on-board the vehicle 14. Details such as power supply connections and physical installation particulars have been omitted for the sake of clarity. The slave controller 16 is connected to an antenna circuit 18 on the one hand and to a plurality of electrical sub-systems 20 of the vehicle on the other hand.

The antenna circuit 18 includes an antenna not shown. The basic function of the antenna circuit 18 is to pick-up the RF signal issued by the remote transmitter 12.

FIG. 3 illustrates in detail the slave controller 16. The slave controller 16 includes a control module 22. The control module 22 has an antenna circuit input 23 for connection to the antenna circuit 18 and a set of ports 25 for connection to respective electrical sub-systems 20 of the vehicle 14. Each port 25 can be unidirectional or bi-directional, depending upon the particular electrical sub-system with which it connects. A unidirectional port is a port that can act either as an input where the port receives information from the electrical sub-system with which it connects, or as an output where the port sends a signal to the electrical sub-system with which it connects, but not both. A bi-directional port is a port that can act as an input and as an output in circumstances where the electrical sub-system can send signals to the control module 22 or receive signals from the control module 22.

The control module 22 is essentially a computing apparatus including a Central Processing Unit (CPU) 24 connected to a storage medium or memory 26 over a data bus 28. Note that although the drawings show the memory 26 as a single block, the memory 26 can be realized as several physical storage units independent from one another, with identical or different data storage properties, such as volatile, non-volatile, etc.

The memory 26 holds program data in the form of program instructions for execution by the CPU 24, in accordance with which the slave controller 16 will perform its intended function. It is advantageous to store the program data in a non-volatile unit of the memory 26 to avoid loss of data when no electrical power is supplied to the slave controller 16.

In a specific example of implementation, the vehicle 14 in which the slave controller 16 is placed has a manual transmission. In order to allow the remote starting of the vehicle engine, the slave controller 16 will perform a transmission state check to determine if the engine is in driving engagement with the vehicle wheels. When the user parks the vehicle, he or she will initiate the transmission state check while still inside the cabin and before the engine has been shut down. The transmission state check is initiated by operating a component of the vehicle inside the cabin. Such component can be any component that can be accessible and that can be recognized by the control module 22 as having been operated. For the purpose of this specification, “component” excludes any switches or controls that are dedicated to the slave controller 16, such as its master on/off switch. Examples of components that can be operated include the handbrake, the brake pedal, the lights (the interior lights or the exterior lights of the vehicle), the cigarette lighter, a flasher, electric seat control, remote mirror control, heating and/or ventilation system, defrost system, electric roof control, electric window control, trunk and wipers among others. In this example, the components have respective primary purposes that are unrelated to the operation of the remote vehicle starting system 10 and they are used in an incidental fashion to initiate the transmission state check. In order to recognize the operation of the component in question, a port 25 of the controller module 22 is connected to an electrical sub-system 20 of the component. Typically, by monitoring the state of conduction of the electrical sub-system 20 associated with the component via a port 25, the control module 22 can determine if the component has been operated.

For instance, it has been found practical to monitor the operation of the handbrake to determine when to initiate the transmission state check. A port 25 of the control module 22 connects to the electrical sub-system 20 of the handbrake. When the hand brake is applied, the state of conduction of the electrical sub-system 20 changes (starts to conduct or ceases to conduct) which allows the control module 22 to determine if the handbrake has been actuated.

In order to avoid instances where the transmission state check is initiated unintentionally simply as a result of the normal operation of the handbrake, the program that manages the operation of the control module is designed to trigger the transmission state check only when the handbrake has been operated a plurality of times in a predetermined time window. For example, the program will initiate the transmission state check when the handbrake is applied, released and then applied again within a time frame of about 5 seconds. It should be expressly noted that any other sequence could be selected without departing from the spirit of the invention.

In a possible variant, instead of using a single component to initiate the transmission state check, the control module 22 may be designed to recognize a sequence of operations of several components, such as applying the hand brake followed by tapping the brake pedal twice, again in a predetermined time window. It will be understood that the control module 22 has a port 25 that connects to the respective sub-system of each component involved in the sequence.

The control module 22 will initiate the transmission state check when it recognizes the actuation of one or more of the components in the cabin of the vehicle 14. When the transmission state check is initiated, the control module 22 will maintain the engine of the vehicle 14 running when the user removes the key from the ignition switch. The control module 22 maintains the engine running by supplying electrical power to the electrical sub-systems 20 of the vehicle 14 that are energized when the ignition switch is in the “ON” position. Again, this requires that the appropriate sub-systems 20 of the vehicle 14 be connected to respective ports 25.

While the engine is running the user exits the vehicle 14. The control module 22 detects when the user has left by monitoring the door switch of the vehicle 14. Typically, a door switch is a simple electrical switch whose state of conduction changes when the door opens or closes. The electrical sub-system 20 that includes the door switch is connected to a port 25 allowing the control module 22 to determine when the door opens and when the door closes. When the control module 22 observes a door opening event, followed by a door closing event and when both events happen within a predetermined time window the control module 22 concludes that the user left the vehicle 14 and closed the door.

To complete the transmission state check the user sends a command to the control module 22 via an RF signal issued from the remote transmitter 12, to shut down the engine. The command may be specific and reserved only for the purpose of directing the control module 22 to shut down the engine, or it can be a multi-purpose command that may have a function, which varies with the context. For instance the multi-purpose command may have the effect of starting the engine when the engine is not running and shut down the engine when the engine is running.

When the control module 22 receives the command communicated via the RF signal, it shuts down the engine. At this point the transmission state check is completed and the control module 22 acquires an operative mode that will allow the engine to be started remotely, i.e., when the user issues an engine start command via the remote transmitter 12. Unless this step in the transmission state check is reached, the control module 22 will by default acquire an operative state preventing the starting of the engine remotely in response to an engine start command contained in an RF signal.

One possible refinement of the starting system 10 is to provide the system 10 with the capability of communicating to the user transmission state check status information. Transmission status information includes information such as:
1. Notifying the user that the transmission state check has been initiated;
2. Notifying the user that the transmission state check has been completed;
3. Notifying the user that the transmission state check has been completed but is not considered successful and the control module 22 will not allow the engine to be remotely started;
4. Notifying the user that the transmission state check has been completed and is considered successful and the control module 22 will allow the engine to be remotely started;
5. Notifying the user at any point of the transmission state check one or more steps he or she must perform to prevent the transmission state check from aborting. For example, the user is notified via synthetic speech to leave the vehicle within 30 seconds otherwise the transmission state check will abort.

The above list is only an example and other types of status information about the transmission state check can be communicated to the user without departing from the spirit of the invention.

The control module 22 notifies the user by issuing a status signal on a suitable port 25 that drives an indicator to communicate the status information to the user. The indicator can be audible, visual or a combination of both. Examples of audible indicators include:
1. A buzzer or chime that will produce a sound inside the vehicle to indicate that the transmission status check has been initiated. The buzzer or chime can be dedicated to the function of delivering transmission state check status information or they may also have other purposes as well, such as the buzzer or chime normally present in the cabin of the vehicle to produce sound and alert the user about anomalies or the fact that the lights have been left “on”, etc.
2. A speech synthesizer that will generate an utterance to notify the user that the transmission status check has been initiated. This is a more sophisticated information delivery system that uses a dedicated speech synthesizer or an existing speech synthesizer if the vehicle already has one.
3. The horn that can be set to provide a notification outside the vehicle.

Examples of visual indicators include:
1. One or more lights on the instrument panel or use of the interior lighting system that can be set to flash in a way to indicate to the user that the transmission state check has been initiated;
2. A display panel that provides a visual indication by text or icons on the state of the transmission status check;
3. The lights outside the vehicle that can be flashed to indicate a particular status of the transmission state check.

In one possible example, a simple audible indicator is used to notify the user that the transmission state check has been initiated. So when the user operates the one or more component in the cabin of the vehicle in the right sequence to trigger the transmission state check, the control module 22 will send the status signal to the audible indicator that will produce a sound to explicitly notify the user that the transmission state check has been properly initiated.

In another specific example the status signal issued by the control module 22 drives the indicator via an RF signal. Specifically, the control module 22 issues an RF signal containing the status information and that RF signal is picked up at a remote location to drive a local indicator. This general approach can be used in the context of a bi-directional transmitter 12, designed to send RF signals and to receive RF signals from the control module 22. The indicator on the transmitter 12 can be audible, visual or a combination of both.

In another example of implementation of the invention, the control module 22 is provided with an interlock that will prevent the control module 22 to be used inadvertently in an operative state suitable for a vehicle with an automatic transmission, when in fact the vehicle is equipped with a manual transmission. Remote control systems are normally designed such that they can be installed in a wide range of vehicles, which may have automatic or manual transmissions. It is up to the technician performing the installation to configure the system properly such that it fits the specific vehicle in which it is being installed. In order to fit vehicles with automatic and manual transmissions, the control module 22 can be set to function in an automatic transmission operative state and a manual transmission operative state. One of the distinctions between the two states is that in the manual transmission operative state, a transmission state check is performed while in the automatic transmission operative state, no such procedure is required.

The control module 22 in accordance with the invention has an interlock that will prevent the control module 22 from acquiring the automatic transmission operative state in case the vehicule in which the system is being installed has a manual transmission. By “interlock” is meant a functionality that may require hardware components, software components or both to be implemented. In a specific example of implementation, the control module 22 includes an electrical connector via which the internal circuitry of the control module 22 connects to electrical sub-systems 20 of the vehicle 14 that provide status information about one or more components which are necessary to the control module 22 in order to operate in the manual transmission operative state. One such component is the handbrake of the vehicle.

In the example where the user operates the handbrake several times in order to trigger the transmission state check, the control module 22 can detect the handbrake operation by observing the state of conduction of the electrical sub-system 20 to which the handbrake connects.

The electrical connector on the control module (not shown) includes two separable parts, one with electrical terminals in the form of pins the other with electrical terminals in the form of sockets, which engage one another to establish respective electrical connections when the two parts are mated. The electrical terminals connect with electrical components on the side of the control module 22 and on the side of the electrical sub-systems 20 of the vehicle. The control module 22 includes an electrical circuit whose state changes when the parts of the electrical connector are separated which allows the control module 22 to detect if the connections with the electrical sub-systems 20 whose status information is required to operate in the manual transmission state, are in fact made. Several possibilities exist to realize this:
1. The connector includes a manually operated electrical switch. The arrangement is such that when one of the parts of the connector is brought to engage the other part, it mechanically engages the switch to change its state of conduction;
2. Instead of using a manually operated switch one could consider using an opto-electric one which responds to changes in a light path caused when the two connector parts are separated or mated;
3. short-circuiting two unused terminals on one part of the connector. When the connector parts are mated, the state of conduction between the terminals corresponding to the short-circuited ones will change from an open state to the closed state;

Instead of monitoring the state of an electrical system, in some instances the interlock may be realized by programming only, where the program operating the control module 22 will observe the presence of signals or simply voltages at the terminals of the electrical connector that would manifest themselves if, in fact, a connection to the handbrake sub-system or to any other relevant sub-system is made.

The control module 22 detects the interlock state and if it senses that components which are necessary for the operation in the manual transmission mode are in fact connected to the control module 22, it will be precluded from acquiring the operative state suitable for an automatic transmission vehicle. In this fashion, should the technician that installs the remote vehicle starting system inadvertently program the control module 22 to work in the automatic transmission mode when the vehicle has a manual transmission, the control module 22 will either reject the programming or automatically revert to the manual transmission mode.

Although various embodiments have been illustrated, this was for the purpose of describing, but not limiting, the invention. Various modifications will become apparent to those skilled in the art and are within the scope of this invention, which is defined more particularly by the attached claims.

1) A slave controller for mounting in a vehicle having:
a) an engine for driving at least one wheel of the vehicle via a manual transmission;
b) a cabin having a plurality of components for operation by an user of the vehicle while being in the cabin, the plurality of components including an ignition switch for receiving a key;
c) said slave controller comprising:
i) a control module having an output, said control module being responsive to an RF signal conveying an engine start command for starting the engine;
ii) said control module capable to perform a transmission state check to determine if the engine is in a driving relationship with the wheel, when said transmission state check is performed and the control module determines that the engine is in a driving relationship with the wheel said control module acquiring a operational state preventing starting of the engine in response to the RF signal;
iii) said transmission state check including preventing the engine from shutting down when the key is removed from the ignition switch;
said control module responsive to actuation of one or more of the plurality of components to initiate the transmission state check, said components being selected in the group consisting of brake pedal a light, a cigarette lighter, heating or ventilation system, a flasher, electric seat control, wipers, electric defroster, remote mirror control and electric window control, electric roof control and trunk.

2) A slave controller as defined in claim 1, wherein the transmission state check includes determining if the user has left the cabin of the vehicle.

3) A slave controller as defined in claim 2, wherein said control module can detect if a door of the vehicle is opened or closed to determine if the user leaves the cabin of the vehicle.

4) A slave controller as defined in claim 3, wherein the vehicle has a door switch having a state of conduction that changes in dependence of whether the door of the vehicle is closed or opened, said control module observing the state of conduction of the door switch to determine if the user has left the cabin of the vehicle.

5) A slave controller as defined in claim 4, wherein the slave controller determines that the user has left the cabin of the vehicle by observing a change in the state of conduction of the door switch indicative of an opening of the door of the vehicle followed by a change in the state of conduction of the door switch indicative of a closing of the door of the vehicle.

6) A slave controller as defined in claim 2, wherein said slave controller is responsive to an RF signal containing an engine stop command to stop the engine.

7) A slave controller as defined in claim 6, wherein after reception of the RF signal containing the engine stop command said control module terminates said transmission state check.

8) A slave controller as defined in claim 1, wherein said control module initiates the transmission state check without need of receiving a command conveyed via an RF signal.

9) A slave controller for mounting in a vehicle having:
a) an engine for driving at least one wheel of the vehicle via a manual transmission;
b) a cabin having a plurality of components for operation by an user of the vehicle while being in the cabin, the plurality of components including an ignition switch for receiving a key;
c) said slave controller comprising:
i) a control module being responsive to an RF signal containing an engine start command for starting the engine;
ii) said control module capable to perform a transmission state check to determine if the engine is in a driving relationship with the wheel, when said transmission state check is performed and the control module determines that the engine is in a driving relationship with the wheel said control module acquiring a operational state preventing starting of the engine in response to the RF signal;
iii) said transmission state check including preventing the engine from shutting down when the key is removed from the ignition switch;
iv) when the transmission state check is being initiated by said control module, said control module is operative to generate a status signal for alerting the user about a status of the transmission state check.

10) A slave controller as defined in claim 9, wherein the transmission state check includes determining if the user leaves the cabin of the vehicle.

11) A slave controller as defined in claim 10, wherein said control module can detect if a door of the vehicle is opened or closed to determine if the user has left the cabin of the vehicle.

12) A slave controller as defined in claim 11, wherein the vehicle has a door switch having a state of conduction that changes in dependence of whether the door of the vehicle is closed or opened, said control module observing the state of conduction of the door switch to determine if the user has left the cabin of the vehicle.

13) A slave controller as defined in claim 12, wherein the slave controller determines that the user leaves the cabin of the vehicle by observing a change in the state of conduction of the door switch indicative of an opening of the door of the vehicle followed by a change in the state of conduction of the door switch indicative of a closing of the door of the vehicle.

14) A slave controller as defined in claim 9, wherein said slave controller is responsive to an RF signal containing an engine stop command to stop the engine.

15) A slave controller as defined in claim 14, wherein after reception of the RF signal containing the engine stop command said control module terminates said transmission state check.

16) A slave controller as defined in claim 9, wherein said status signal indicates that the transmission state check is initiated.

17) A slave controller as defined in claim 9, wherein said status signal indicates that the transmission state check is completed.

18) A slave controller as defined in claim 9, wherein said status signal indicates that the transmission state check is completed and said slave controller upon reception of an RF signal containing an engine start command will start the engine.

19) A slave controller as defined in claim 9, wherein said status signal indicates that the transmission state check is completed and said slave controller upon reception of an RF signal containing an engine start command will be precluded from starting the engine.

20) A slave controller as defined in claim 9, wherein the status signal is capable of driving an indicator alerting the user about the status of the transmission state check.

21) A slave controller as defined in claim 20, wherein said indicator audibly alerts the user.

22) A slave controller as defined in claim 20, wherein said indicator visually alerts the user.

23) A slave controller as defined in claim 20, wherein said indicator alerts the user visually and audibly.

24) A slave controller as defined in claim 20, wherein said status signal drives the indicator via an RF signal.

25) A slave controller as defined in claim 24, wherein the indicator is located on a remote transmitter capable to receive information from said control module via the RF signal.

26) A slave controller as defined in claim 20, wherein the indicator delivers an alert to the user in the cabin.

27) A slave controller as defined in claim 20, wherein the indicator delivers an alert to the user outside the cabin.

28) A slave controller for mounting in a vehicle having an engine, said slave controller capable of being configured to function in a vehicle having an automatic transmission or in a vehicle having a manual transmission, said slave controller having a control module;
a) responsive to an RF signal containing an engine start command to start the engine;
b) capable to acquire a plurality of operative states, including an automatic transmission operative state and a manual transmission operative state, said automatic transmission operative state being suitable when the slave controller is mounted in a vehicle having an automatic transmission and said manual transmission operative state being suitable when said slave controller is mounted in a vehicle having a manual transmission;
c) said control module including an input to obtain information from at least one component required during the manual transmission operative state;
d) said control module including an interlock precluding said control module from acquiring the automatic transmission operative state when the at least one component communicates with said input.

29) A slave controller as defined in claim 28, wherein said control module includes an electrical connector having at least two parts which are capable of acquiring either one of a separated condition and a mated condition, the component communicating with said input when said parts are in a mated condition, said interlock further including an electrical circuit, a state of said electrical circuit being determined by the condition of said two parts.

30) A slave controller as defined in claim 29, wherein said interlock determines that the at least one component communicates with said input by observing the state of said electrical circuit.

31) A slave controller as defined in claim 30, wherein the at least one component is a hand brake of the vehicle.

32) A slave controller for mounting in a vehicle having:
a) an engine for driving at least one wheel of the vehicle via a manual transmission;
b) a cabin having a plurality of components for operation by an user of the vehicle while being in the cabin, the plurality of components including an ignition switch for receiving a key;
c) said slave controller comprising:
i) a control module having an output, said control module being responsive to an RF signal conveying an engine start command for starting the engine;
ii) said control module capable to perform a transmission state check to determine if the engine is in a driving relationship with the wheel, when said transmission state check is performed and the control module determines that the engine is in a driving relationship with the wheel said control module acquiring a operational state preventing starting of the engine in response to the RF signal;
iii) said transmission state check including preventing the engine from shutting down when the key is removed from the ignition switch;
said control module responsive to actuation of one or more of the plurality of components a plurality of times to initiate the transmission state check.

33) A slave controller as defined in claim 32, wherein the transmission state check includes determining if the user has left the cabin of the vehicle.

34) A slave controller as defined in claim 33, wherein said control module can detect if a door of the vehicle is opened or closed to determine if the user leaves the cabin of the vehicle.

35) A slave controller as defined in claim 34, wherein the vehicle has a door switch having a state of conduction that changes in dependence of whether the door of the vehicle is closed or opened, said control module observing the state of conduction of the door switch to determine if the user has left the cabin of the vehicle.

36) A slave controller as defined in claim 35, wherein the slave controller determines that the user has left the cabin of the vehicle by observing a change in the state of conduction of the door switch indicative of an opening of the door of the vehicle followed by a change in the state of conduction of the door switch indicative of a closing of the door of the vehicle.

37) A slave controller as defined in claim 32, wherein said slave controller is responsive to an RF signal containing an engine stop command to stop the engine.

38) A slave controller as defined in claim 37, wherein after reception of the RF signal containing the engine stop command said control module terminates said transmission state check.

39) A slave controller as defined in claim 32, wherein said control module initiates the transmission state check without need of receiving a command conveyed via an RF signal.

40) A slave controller as defined in claim 32, wherein the plurality of components include a handbrake, said control module is responsive to actuation of the handbrake a plurality of times to initiate the transmission state check.

41) A slave controller as defined in claim 40, wherein said control module is responsive to actuation of the handbrake a plurality of times within a predetermined time window to initiate the transmission state check.

42) A slave controller for mounting in a vehicle having:
a) an engine for driving at least one wheel of the vehicle via a manual transmission;
b) a cabin having a plurality of components for operation by an user of the vehicle while being in the cabin, the plurality of components including an ignition switch for receiving a key;
c) said slave controller comprising:
i) a control module having an output, said control module being responsive to an RF signal conveying an engine start command for starting the engine;
ii) said control module capable to perform a transmission state check to determine if the engine is in a driving relationship with the wheel, when said transmission state check is performed and the control module determines that the engine is in a driving relationship with the wheel said control module acquiring a operational state preventing starting of the engine in response to the RF signal;
iii) said transmission state check including preventing the engine from shutting down when the key is removed from the ignition switch;
said control module responsive to actuation of at least two components of the plurality of components to initiate the transmission state check.

43) A slave controller as defined in claim 42, wherein the transmission state check includes determining if the user has left the cabin of the vehicle.

44) A slave controller as defined in claim 43, wherein said control module can detect if a door of the vehicle is opened or closed to determine if the user leaves the cabin of the vehicle.

45) A slave controller as defined in claim 44, wherein the vehicle has a door switch having a state of conduction that changes in dependence of whether the door of the vehicle is closed or opened, said control module observing the state of conduction of the door switch to determine if the user has left the cabin of the vehicle.

46) A slave controller as defined in claim 45, wherein the slave controller determines that the user has left the cabin of the vehicle by observing a change in the state of conduction of the door switch indicative of an opening of the door of the vehicle followed by a change in the state of conduction of the door switch indicative of a closing of the door of the vehicle.

47) A slave controller as defined in claim 43, wherein said slave controller is responsive to an RF signal containing an engine stop command to stop the engine.

48) A slave controller as defined in claim 47, wherein after reception of the RF signal containing the engine stop command said control module terminates said transmission state check.

49) A slave controller as defined in claim 42, wherein said control module initiates the transmission state check without need of receiving a command conveyed via an RF signal.

50) A slave controller as defined in claim 42, wherein said control module is responsive to actuation of the at least two components in a predetermined sequence to initiate said transmission state check.

51) A slave controller as defined in claim 50, wherein said control module is responsive to actuation of the at least two components in a predetermined sequence and within a predetermined time window to initiate said transmission state check.
